(19) United States
(12) Patent Application Publication
(10) Pub. No.: US 2012/0155609 A1
(43) Pub. Date: Jun. 21, 2012

(54) SYSTEM AND METHOD OF LOW DOSE EXPOSURE AIDED POSITIONING (LEAP) FOR DIGITAL RADIOGRAPHY

(75) Inventors: Ryan James Lemminger, Waukesha, WI (US); Rowland Frederick Saunders, Hartland, WI (US)

(73) Assignee: GENERAL ELECTRIC COMPANY, Schenectady, NY (US)

(21) Appl. No.: 12/972,915

(22) Filed: Dec. 20, 2010

(51) Int. Cl. G01N 23/04

(52) U.S. Cl. 378/62; 378/205; 378/98.2

(57) ABSTRACT

A system and method for improved imaging of a subject through the use of low dose exposure aided positioning is provided. The subject is positioned in an X-ray imaging system and imaged with a low dose pre-shot X-ray exposure to verify the positioning of the subject. If the subject's positioning is acceptable, the subject is then imaged with a full dose X-ray exposure. If the subject's positioning is not acceptable, the subject is repositioned and re-imaged with a low dose pre-shot X-ray exposure until the subject's positioning is acceptable. The low dose pre-shot X-ray exposure may take the form of a low dose X-ray imaging sequence where the radiation dose is less than the radiation dose of a full dose X-ray exposure.

### BACKGROUND OF THE INVENTION

This disclosure relates generally to X-ray imaging systems, and more particularly to a system and method for improved X-ray imaging of a subject through the use of low dose exposure aided positioning.

A number of X-ray imaging systems of various designs are known and are presently in use. Such systems are generally based upon generation of X-rays that are directed toward a subject of interest. The X-rays traverse the subject and impact a film, an imaging plate (cassette) or a digital detector. Increasingly, such X-ray imaging systems use digital circuitry for detecting the X-rays, which are attenuated, scattered or absorbed by the intervening structures of the subject. In medical imaging contexts, for example, such systems may be used to visualize the internal structures, tissues and organs of a subject for the purpose screening or diagnosing ailments. In other contexts, parts, structures, baggage, parcels, and other subjects may be imaged to assess their contents, structural integrity or other purposes.

X-ray imaging generally includes positioning a subject within an X-ray imaging system, initiating an X-ray exposure by directing generated X-rays towards the subject and acquiring X-ray images of the subject. Often times during clinical use, a review of the X-ray images may reveal errors related to image quality and/or positioning accuracy of the subject, for example, the subject may not have been properly positioned within the X-ray field. To correct this type of error, the subject must re-positioned and another X-ray image acquired. Re-acquiring the X-ray image exposes the subject to additional X-rays (more X-ray dose), which is obviously undesirable.

With analog or computed radiography systems, the quality of the X-ray image and positioning accuracy of the subject may only be reviewed after the analog film or imaging plate (cassette) has been developed and/or processed. Typically, developing an analog film or reading a imaging plate (cassette) requires several minutes at least, during which time, the subject may have left the examination room, for example, or may otherwise be unavailable. If the X-ray image or positioning accuracy is found to be less then optimal, the subject may need to be recalled and re-positioned. Recalling and re-positioning the subject is a time consuming process, which may in turn increases the X-ray dose administered to the subject and affects the throughput of the X-ray imaging system.

Therefore, there is a need for an improved X-ray imaging system and method that provides for rapid verification of proper positioning of a subject being imaged in an X-ray imaging system and minimizes the X-ray exposure or X-ray dose of the subject being imaged.

### BRIEF DESCRIPTION OF THE INVENTION

In accordance with an aspect of the disclosure, a method for improving the quality of X-ray images generated by an X-ray imaging system, the X-ray imaging system comprising an X-ray source and an X-ray detector, the method comprising positioning a subject between the X-ray source and the X-ray detector; imaging the subject with a low dose pre-shot X-ray exposure to obtain a low dose pre-shot X-ray image, wherein the low dose pre-shot X-ray exposure has a radiation dose level that is less than the radiation dose level of a full dose X-ray exposure; displaying the low dose pre-shot X-ray image along with recommended X-ray imaging parameters for use during a subsequent X-ray exposure; analyzing the low dose pre-shot X-ray image to determine the positioning of the subject relative to the X-ray source and the X-ray detector; adjusting the positioning of the subject relative to at least one of the X-ray source and the X-ray detector; and imaging the subject with a full dose X-ray exposure.

In accordance with an aspect of the disclosure, a method for verifying the positioning of a subject in an X-ray imaging system before imaging the subject with a full dose X-ray exposure comprising positioning the subject in the X-ray imaging system; imaging the subject with a low dose pre-shot X-ray exposure to obtain a low dose pre-shot X-ray image, wherein the low dose pre-shot X-ray exposure has a radiation dose level that is less than the radiation dose level of a full dose X-ray exposure; displaying the low dose pre-shot X-ray image and displaying a plurality of X-ray imaging parameters for use during a subsequent X-ray exposure; and verifying the positioning of the subject in the X-ray imaging system via the low dose pre-shot X-ray image before imaging the subject with a full dose X-ray exposure.

In accordance with an aspect of the disclosure, a method for improving the quality of X-ray images generated by an X-ray imaging system, the method comprising positioning a subject in the X-ray imaging system; imaging the subject with a low dose pre-shot X-ray exposure to obtain a low dose pre-shot X-ray image, wherein the low dose pre-shot X-ray exposure has a radiation dose level that is less than the radiation dose level of a full dose X-ray exposure; displaying the low dose pre-shot X-ray image along with recommended X-ray imaging parameters for use during a subsequent X-ray exposure; and imaging the subject with the full dose X-ray exposure.

In accordance with an aspect of the disclosure, a method for improving the quality of X-ray images generated by an X-ray imaging system, the method comprising positioning a subject in the X-ray imaging system; imaging the subject with a low dose pre-shot X-ray exposure to obtain a low dose pre-shot X-ray image, wherein the low dose pre-shot X-ray exposure has a radiation dose level that is less than the radiation dose level of a full dose X-ray exposure; processing the low dose pre-shot X-ray image to provide a plurality of X-ray imaging parameters for use during a subsequent X-ray exposure; displaying the low dose pre-shot X-ray image along with the plurality of X-ray imaging parameters for use during the subsequent X-ray exposure; and imaging the subject with the full dose X-ray exposure.

Various other features, aspects, and advantages will be made apparent to those skilled in the art from the accompanying drawings and detailed description thereof.

### BRIEF DESCRIPTION OF THE DRAWINGS

FIG. 1 is a block diagram of an exemplary embodiment of a digital X-ray imaging system; and

FIG. 2 is a flow diagram of an exemplary embodiment of a method of low dose exposure aided positioning (LEAP) for digital radiography.

### DETAILED DESCRIPTION OF THE INVENTION

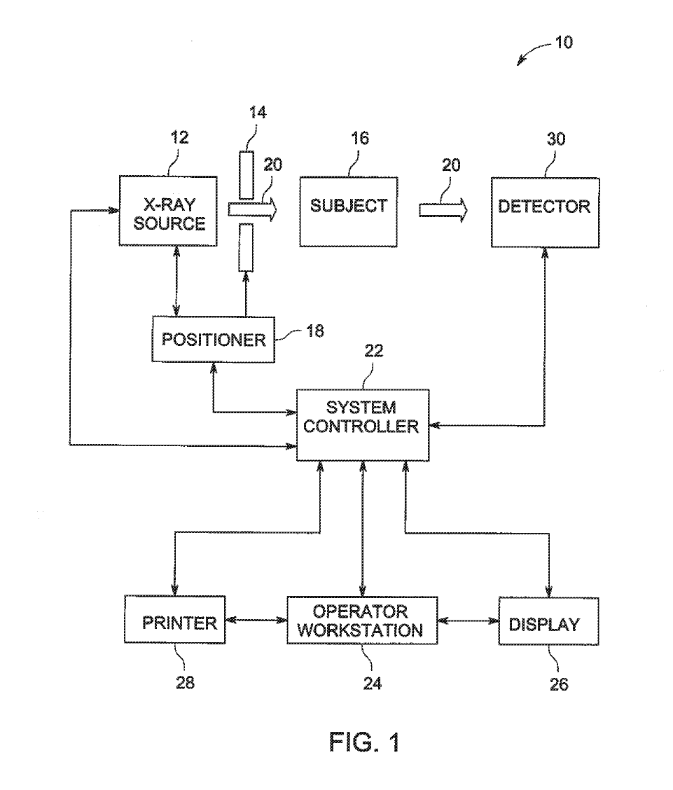

Referring to the drawings, FIG. 1 illustrates a block diagram of an exemplary embodiment of a digital X-ray imaging system 10. It should be appreciated by those skilled in the art that this disclosure is applicable to different types of digital X-ray imaging systems, such as digital radiography (RAD), mammography, tomosynthesis, vascular and computed tomography (CT) imaging systems. The digital X-ray imaging system 10 includes an X-ray source 12, a collimator 14 adjacent to the X-ray source 12, a subject 16 to be imaged, a digital X-ray detector 30, and a positioner 18. The positioner 18 is a mechanical controller coupled to X-ray source 12 and collimator 14 for controlling the positioning of X-ray source 12 and collimator 14.

The digital X-ray imaging system 10 is designed to create images of the subject 16 by means of an X-ray beam 20 emitted by X-ray source 12, and passing through collimator 14, which forms and confines the X-ray beam 20 to a desired region, wherein the subject 16, such as a human patient, an animal or an object, is positioned. A portion of the X-ray beam 20 passes through or around the subject 16, and being altered by attenuation and/or absorption by tissues within the subject 16, continues on toward and impacts the digital X-ray detector 30. In an exemplary embodiment, the digital X-ray detector 30 may be a fixed detector or a portable detector. In an exemplary embodiment, the digital X-ray detector 30 may be a digital flat panel X-ray detector. The digital X-ray detector 30 converts X-ray photons received on its surface to lower energy light photons, and subsequently to electric signals, which are acquired and processed to reconstruct an image of internal anatomy within the subject 16. The digital X-ray detector 30 is designed to eliminate electromagnetic interference (EMI) and prevent artifacts from forming on the X-ray images.

The digital X-ray imaging system 10 further includes a system controller 22 coupled to X-ray source 12, positioner 18, and digital X-ray detector 30 for controlling operation of the X-ray source 12, positioner 18, and digital X-ray detector 30. The system controller 22 may supply both power and control signals for imaging examination sequences. In general, system controller 22 commands operation of the X-ray system to execute examination protocols and to process acquired image data. The system controller 22 may also include signal processing circuitry, based on a general purpose or application-specific computer, associated memory circuitry for storing programs and routines executed by the computer, as well as configuration parameters and image data, interface circuits, and so forth.

The system controller 22 may further include at least one processor designed to coordinate operation of the X-ray source 12, positioner 18, and digital X-ray detector 30, and to process acquired image data. The at least one processor may carry out various functionality in accordance with routines stored in the associated memory circuitry. The associated memory circuitry may also serve to store configuration parameters, operational logs, raw and/or processed image data, and so forth. In an exemplary embodiment, the system controller 22 includes at least one image processor to process acquired image data.

The system controller 22 may further include interface circuitry that permits an operator or user to define imaging sequences, determine the operational status and health of system components, and so-forth. The interface circuitry may allow external devices to receive images and image data, and command operation of the X-ray system, configure parameters of the system, and so forth.

The system controller 22 may be coupled to a range of external devices via a communications interface. Such devices may include, for example, an operator workstation 24 for interacting with the X-ray system, processing or reprocessing images, storing images, viewing images, and so forth. In the case of tomosynthesis systems, for example, the operator workstation 24 may serve to create or reconstruct image slices of interest at various levels in the subject based upon the acquired image data. Other external devices may include a display 26 or a printer 28. In general, these external devices 24, 26, 28 may be local to the image acquisition components, or may be remote from these components, such as elsewhere within a medical facility, institution or hospital, or in an entirely different location, linked to the image acquisition system via one or more configurable networks, such as the Internet, intranet, virtual private networks, and so forth. Such remote systems may be linked to the system controller 22 by any one or more network links. It should be further noted that the operator workstation 24 may be coupled to the display 26 and printer 28, and may be coupled to a picture archiving and communications system (PACS). Such a PACS might be coupled to remote clients, such as a radiology department information system or hospital information system, or to an internal or external network, so that others at different locations may gain access to image data.

The data acquired by digital X-ray imaging system 10 may be corrupted by various sources of EMI (not shown) depending upon the context in which the system 10 is used, and the devices that may surround the system 10 or be used in conjunction with it, EMI of various frequencies and amplitudes, some of which may be in phase and out of phase with the acquired data may affectively be superimposed on the acquired data as it is collected. The digital X-ray imaging system 10 allows for characterization and correction of such EMI and thus reduction of image artifacts that would otherwise be present in the image data and visible in reconstructed images based upon the data. The characterization and correction itself may be carried out in any of the foregoing circuitry, including the detector circuitry or the system controller 22. Moreover, where desired, the EMI may be characterized and corrected in a post-processing step that may be partially or entirely remote from the digital X-ray imaging system 10 itself.

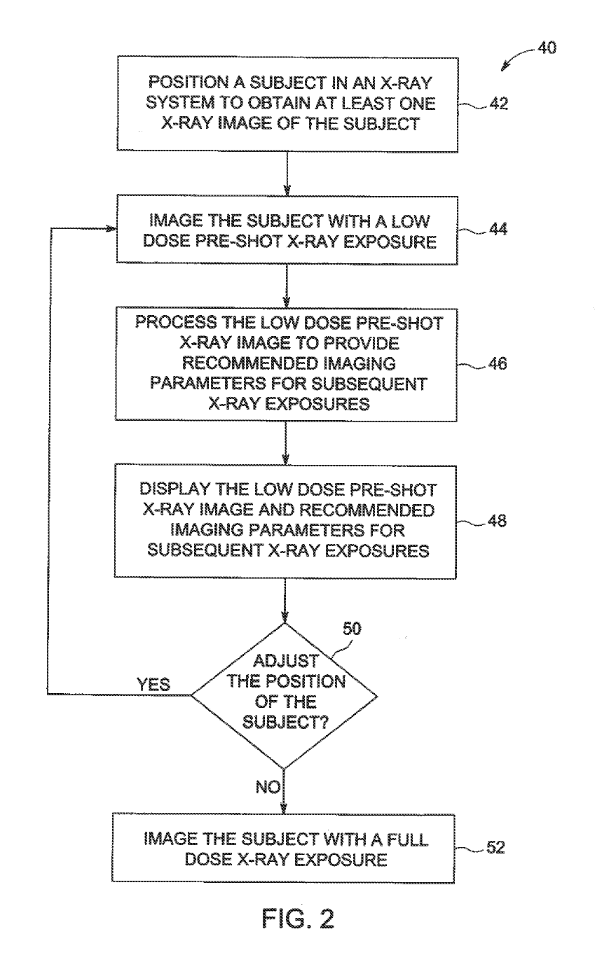

FIG. 2 illustrates a flow diagram of an exemplary embodiment of a method 40 of low dose exposure aided positioning (LEAP) for digital radiography. The method 40 is preferably implemented on a digital X-ray imaging system 10. The digital X-ray imaging system 10 may display a low dose pre-shot or preview image prior to displaying a full dose processed image. As further described below, a low dose pre-shot or preview image is a preliminary image that may provide an initial image of the subject. For example, the low dose pre-shot or preview image may be determined by only processing a reduced resolution image, for example, a smaller number of X-ray pixels, less than the total number of available X-ray pixels are processed and displayed. The full dose processed image is an X-ray image in which every available X-ray pixel is processed and displayed.

The low dose pre-shot or preview image may be employed to verify and correct positioning of the subject within the X-ray field of the X-ray system. If it is determined from the low dose pre-shot or preview image that the subject was not properly positioned within the X-ray field of the X-ray system, then the subject may be properly positioned and re-imaged. Consequently, this may prevent an X-ray image with unacceptable image quality or incorrect subject positioning from being printed (or sent to a PACS), and allow a new image acquisition workflow to be performed while the subject is still positioned within the X-ray system.

The present method employs a low dose X-ray exposure prior to a full dose clinical X-ray exposure. The low dose X-ray exposure provides the operator of the X-ray imaging system with feedback regarding the quality of subject positioning within the X-ray imaging system. The low dose X-ray exposure can be used as a reference for repositioning the subject, and may be repeated until the desired subject positioning is obtained.

Referring to method 40, the first step 42 of the method 40 includes positioning a subject within a digital X-ray imaging system in order to obtain at least one X-ray image of the subject. In an alternate embodiment, the X-ray source 12, collimator 14 and/or X-ray detector 30 of the digital X-ray imaging system 10 may be positioned in order to obtain at least one X-ray image of the subject. In an exemplary embodiment, the subject may be a human patient, an animal or an object.

The next step 44 of method 40 includes imaging the subject with a low dose pre-shot X-ray exposure. A low dose pre-shot X-ray exposure is an acquisition of an X-ray image of a subject that is acquired using a lower X-ray dose that is lower than the typically X-ray dose used for normal X-ray imaging. The low dose X-ray imaging dose is around 1% to 4% of a typical full dose X-ray imaging dose. For this low dose pre-shot X-ray exposure, the X-ray imaging parameters may be the same or different then the X-ray imaging parameters for a full dose X-ray exposure. These X-ray imaging parameters are preferably pre-set and placed into a table, which may be indexed by factors such as anatomical view and subject age, for example.

The next step 46 of method 40 includes processing the low dose pre-shot X-ray image in order to provide recommended X-ray imaging parameters for a subsequent X-ray exposure. The low dose pre-shot X-ray exposures may be employed to optimize X-ray imaging parameters for the full dose exposure. For example, the low dose X-ray exposure may be used to provide zero point parameters, saturation management parameters, field of view optimization parameters, and/or spatial physical filter parameters.

Zero point parameters are parameters that are automatically determined by the X-ray imaging system itself in response to the low dose X-ray exposure. For example, zero point parameters may include X-ray source current, exposure time for X-ray, X-ray source voltage, focal spot, or other X-ray parameters. Additionally, automatically processing the low dose image may be used to determine the thickness of the subject as well as the subject's composition. Once the thickness and composition are known, the X-ray image acquisition parameters of the full dose exposure may be optimized to provide the best view. For example, once the thickness of the subject is known, the dynamic range of the X-ray imaging system may be altered to provide the greatest detail of the region of interest.

Saturation management parameters are parameters that relate to the imaging of thin tissue, such as a hand. For example, the X-ray detector may saturate with a normal full X-ray dose exposure. To prevent saturation, the low dose image may be analyzed and then pasted back with the full dose image thus virtually extending the saturation range of the detector.

Field of view optimization parameters are parameters that relate to the operator selecting the region of interest from the low dose image. Then, the X-ray imaging system may be positioned to automatically move to the center of the region of interest as well as minimize the region of interest before acquiring the full dose exposure. Centering and minimizing the field of view of the X-ray image to the region of interest may reduce the dose to the subject.

Spatial physical filter parameters are parameters that relate to a low dose image being processed to determine the thickness of the subject over the image. The average thickness data may then be supplied to the collimator, which may then filter the field of view spatially. That is, the collimator may be activated to deliver a lower dose to thinner regions and a higher dose to thicker regions. Matching dose to region thickness may yield a better image quality as well as a lower overall dose to the subject. For example, the image quality may be improved because adjustment to different anatomical structures may improve the signal-to-noise ratio of the X-ray image.

The next step 48 of method 40 includes displaying the low dose pre-shot X-ray image and display the recommended X-ray imaging parameters for subsequent X-ray exposures. The low dose pre-shot X-ray image is displayed and the accuracy of the subject positioning is calculated as further described below.

At step 50, a decision whether or not to adjust the subject positioning is made. In a preferred embodiment, the decision to adjust the position of the subject is made by an operator of the X-ray imaging system visualizing the displayed low dose pre-shot X-ray image. That is, the operator observes the pre-shot X-ray image and makes a decision whether or not to reposition the subject.

In an alternate embodiment, a computer algorithm may be used to make the decision whether or not to reposition the subject. For example, the computer algorithm may use image segmentation to detect whether a selected anatomy is in the field of view of the X-ray detector. That is, when the subject is first positioned, the operator selects the type of X-ray image to be taken from among a menu of available image types. For example, the operator may select “hand” from the menu when the operator desires to image a subject's hand. The subject is then imaged with the low dose pre-shot X-ray exposure. The resulting low dose pre-shot X-ray image is then processed via a computer algorithm, such as segmentation for example, to determine the positioning of the subject within the image. That is, the computer algorithm analyzes the low dose X-ray image and recognizes the positioning of the subject, for instance, by identifying the relative locations of landmarks within the image. If the computer algorithm determines that the positioning of the subject is acceptable, then a full dose X-ray exposure is taken. If the computer algorithm does not determine that the positioning of the subject is acceptable, the computer algorithm prompts the operator for a decision as to whether or not to perform the full dose X-ray exposure.

Returning to step 50 of method 40, the position of the subject is adjusted if necessary. That is, once the low dose pre-shot X-ray image has been acquired, the positioning of the subject may be verified by the operator by visualizing the displayed low dose pre-shot X-ray image and re-positioning the subject, if necessary. Once the subject has been re-positioned, the subject may be imaged again with another low dose pre-shot X-ray exposure to verify the subject's position. The subject may be repeatedly re-positioned until the operator is satisfied with the subject's position within the X-ray field. The total dose of X-ray radiation that the subject may be exposed to during repeated positioning and X-ray image verification steps is considerably lower than a full dose X-ray exposure. In an alternate embodiment, the X-ray source 12, collimator 14 and/or X-ray detector 30 of the digital X-ray imaging system 10 may be positioned in order to obtain at least one X-ray image of the subject.

Finally, at step 52, the subject is imaged with a full dose X-ray exposure. That is, once the position of the subject has been verified, the full-dose X-ray exposure is acquired.

Preferably, the operator controls the X-ray imaging system and selects the X-ray imaging protocol from a remote acquisition workstation. The acquisition technique for the low dose pre-shot X-ray exposure is preferably automatically selected by the X-ray imaging system. The low dose pre-shot X-ray image is preferably displayed in less than one second to allow the operator to verify subject positioning.

By displaying the recommended X-ray imaging parameters to the operator along with the low dose pre-shot X-ray image, the technique for the full-dose X-ray exposure is no longer completely dependent on the operator's interaction with the X-ray imaging system during exam setup. More specifically, for example, if the operator incorrectly specifies the subject size during exam setup, the operator may change the technique, based on system recommendations, before proceeding to the full-dose V-ray exposure. The updated technique may prevent over exposing the subject to an increased X-ray dose, and/or potentially reduce the exam retake rate due to an inadequate technique.

The low dose pre-shot X-ray image may be employed to verify and correct positioning of the subject within the X-ray field of the X-ray imaging system. If it is determined from the low dose pre-shot X-ray image that the subject was not properly positioned within the X-ray field of the X-ray imaging system, then the subject may be properly positioned and re-imaged. Consequently, this may prevent an X-ray image with unacceptable image quality or incorrect subject positioning from being printed (or sent to a PACS), and allow a new image acquisition workflow to be performed while the subject is still positioned within the X-ray imaging system.

Therefore, the low dose pre-shot X-ray exposures are used to greatly minimize the additional radiation dose received by the subject through repeated full dose X-ray exposures due to improper subject positioning. Other advantages of the present disclosure include rapid verification of subject positioning within the X-ray imaging system, elimination of additional full dose X-ray exposures due to re-imaging improperly positioned subjects, and improved quality of subject positioning because of a much simpler image acquisition workflow.

While the disclosure has been described with reference to various embodiments, those skilled in the art will appreciate that certain substitutions, alterations and omissions may be made to the embodiments without departing from the spirit of the disclosure. Accordingly, the foregoing description is meant to be exemplary only, and should not limit the scope of the disclosure as set forth in the following claims.

What is claimed is:

1. A method for improving the quality of X-ray images generated by an X-ray imaging system, the X-ray imaging system comprising an X-ray source and an X-ray detector, the method comprising:
positioning a subject between the X-ray source and the X-ray detector;
imaging the subject with a low dose pre-shot X-ray exposure to obtain a low dose pre-shot X-ray image, wherein the low dose pre-shot X-ray exposure has a radiation dose level that is less than the radiation dose level of a full dose X-ray exposure;
displaying the low dose pre-shot X-ray image along with recommended X-ray imaging parameters for use during a subsequent X-ray exposure;
analyzing the low dose pre-shot X-ray image to determine the positioning of the subject relative to the X-ray source and the X-ray detector;
adjusting the positioning of the subject relative to at least one of the X-ray source and the X-ray detector; and
imaging the subject with a full dose X-ray exposure.

2. The method of claim 1, wherein the adjusting step includes adjusting the positioning of the subject and re-imaging the subject with a second low dose pre-shot X-ray exposure prior to imaging the subject with the full dose X-ray exposure.

3. The method of claim 1, wherein the recommended X-ray imaging parameters vary between the low dose pre-shot X-ray exposure and the full dose X-ray exposure.

4. The method of claim 3, wherein the recommended X-ray imaging parameters vary according to one of subject size and anatomical view.

5. The method of claim 1, wherein the analyzing step further includes automatically analyzing the low dose X-ray image using a computer algorithm, wherein the computer algorithm employs image segmentation to determine the positioning of the subject.

6. The method of claim 1, further comprising processing the low dose pre-shot X-ray image to provide the recommended X-ray imaging parameters for use during the subsequent X-ray exposure.

7. The method of claim 1, wherein the subsequent X-ray exposure is a low dose X-ray exposure.

8. The method of claim 1, wherein the subsequent X-ray exposure is a full dose X-ray exposure.

9. A method for verifying the positioning of a subject in an X-ray imaging system before imaging the subject with a full dose X-ray exposure comprising;
positioning the subject in the X-ray imaging system;
imaging the subject with a low dose pre-shot X-ray exposure to obtain a low dose pre-shot X-ray image, wherein the low dose pre-shot X-ray exposure has a radiation dose level that is less than the radiation dose level of a full dose X-ray exposure;
displaying the low dose pre-shot X-ray image and displaying a plurality of X-ray imaging parameters for use during a subsequent X-ray exposure; and
verifying the positioning of the subject in the X-ray imaging system via the low dose pre-shot X-ray image before imaging the subject with a full dose X-ray exposure.

10. The method of claim 9, wherein the verifying step includes adjusting the positioning of the subject and re-imaging the subject with a second low dose pre-shot X-ray exposure prior to imaging the subject with the full dose X-ray exposure.

11. The method of claim 9, wherein the verifying step includes automatically verifying the low dose X-ray image using a computer algorithm, wherein the computer algorithm employs image segmentation to determine the positioning of the subject.

12. The method of claim 9, further comprising processing the low dose pre-shot X-ray image to provide the plurality of X-ray imaging parameters for use during the subsequent X-ray exposure.

13. The method of claim 12, wherein the plurality of X-ray imaging parameters include at least one of zero point parameters, saturation management parameters, field of view optimization parameters and spatial physical filter parameters.

14. The method of claim 9, wherein the subsequent X-ray exposure is a low dose X-ray exposure.

15. The method of claim 9, wherein the subsequent X-ray exposure is a full dose X-ray exposure.

16. A method for improving the quality of X-ray images generated by an X-ray imaging system, the method comprising:
positioning a subject in the X-ray imaging system;
imaging the subject with a low dose pre-shot X-ray exposure to obtain a low dose pre-shot X-ray image, wherein the low dose pre-shot X-ray exposure has a radiation dose level that is less than the radiation dose level of a full dose X-ray exposure;
displaying the low dose pre-shot X-ray image along with recommended X-ray imaging parameters for use during a subsequent X-ray exposure; and
imaging the subject with the full dose X-ray exposure.

17. The method of claim 16, further comprising processing the low dose pre-shot X-ray image to provide the recommended X-ray imaging parameters for use during a subsequent X-ray exposure.

18. The method of claim 17, wherein the recommended X-ray imaging parameters include at least one of zero point parameters, saturation management parameters, field of view optimization parameters and spatial physical filter parameters.

19. The method of claim 16, further comprising adjusting the positioning of the subject in the X-ray imaging system and re-imaging the subject with a second low dose pre-shot X-ray exposure prior to imaging the subject with the full-dose X-ray exposure.

20. The method of claim 16, wherein the subsequent X-ray exposure is a low dose X-ray exposure.

21. The method of claim 16, wherein the subsequent X-ray exposure is a full dose X-ray exposure.

22. A method for improving the quality of X-ray images generated by an X-ray imaging system, the method comprising:
positioning a subject in the X-ray imaging system;
imaging the subject with a low dose pre-shot X-ray exposure to obtain a low dose pre-shot X-ray image, wherein the low dose pre-shot X-ray exposure has a radiation dose level that is less than the radiation dose level of a full dose X-ray exposure;
processing the low dose pre-shot X-ray image to provide a plurality of X-ray imaging parameters for use during a subsequent X-ray exposure;
displaying the low dose pre-shot X-ray image along with the plurality of X-ray imaging parameters for use during the subsequent X-ray exposure; and
imaging the subject with the full dose X-ray exposure.

23. The method of claim 22, further comprising adjusting the positioning of the subject in the X-ray imaging system and re-imaging the subject with a second low dose pre-shot X-ray exposure prior to imaging the subject with the full-dose X-ray exposure.

24. The method of claim 22, wherein the plurality of X-ray imaging parameters include at least one of zero point parameters, saturation management parameters, field of view optimization parameters and spatial physical filter parameters.

25. The method of claim 22, wherein the subsequent X-ray exposure is a low dose X-ray exposure.

26. The method of claim 22, wherein the subsequent X-ray exposure is a full dose X-ray exposure.
